(19) United States
(12) Patent Application Publication
(10) Pub. No.: US 2002/0151639 A1
(43) Pub. Date: Oct. 17, 2002

(54) Micronized polyolefins for preparing pigment concentrates

(75) Inventors: Arno Knebelkamp, Essen (DE); Werner Schafer, Essen (DE); Manfred Scheiba, Essen (DE)

Correspondence Address: SCULLY, SCOTT, MURPHY & PRESSER, 400 Garden City Plaza, Garden City, NY, 11530, US

(73) Assignee: GOLDSCHMIDT AG, ESSEN (DE)

(21) Appl. No.: 10/087,018

(22) Filed: Mar. 4, 2002

Related U.S. Application Data
(62) Division of application No. 09/449,128, filed on Nov. 24, 1999.

(30) Foreign Application Priority Data
Nov. 28, 1998 (DE) 198 55 058.8

(51) Int. Cl. C08K 5/01

(52) U.S. Cl. 524/487

(57) ABSTRACT

The present invention relates to the use of micronized polyolefin powders to prepare pigment concentrates for coloring polyolefins. The micronized polyolefins and/or polyolefin waxes are prepared by grinding polyolefins and/or polyolefin waxes to prepare pigment concentrates, wherein the proportion of the particle size fraction smaller than 10 μm is at least 1% by weight, the proportion of the particle size fraction smaller than 100 μm is at least 10% by weight, and the proportion of the particle size fraction smaller than 500 μm is at least 90% by weight.

### FIELD OF THE INVENTION

The present invention relates to micronized polyolefin powders, and in particular to pigment concentrates comprising the micronized polyolefin powders of the present invention for coloring polyolefins.

### BACKGROUND OF THE INVENTION

Polyolefins are normally colored using pigment concentrates (masterbatches). These pigment concentrates, prepared by extrusion processes, comprise the corresponding pigment in concentrations of about 20-70%; a polymeric carrier; and various kinds of substances such as waxes and dispersants which assist the dispersing process and ensure highly uniform distribution (dispersion) of the pigments.

Depending on the target application, particular requirements are imposed on the quality of these pigment concentrates: for coloring thick-walled injection moldings, optimum dispersion of the pigments is not absolutely necessary, since pigment agglomerates or the development of inhomogeneities as a result of inadequate dispersion of the pigments will cause no problems in the end product. In the coloring of a polyolefin film or fiber, on the other hand, inadequate dispersion leads to great problems: in the case of a film, inhomogeneities disrupt the visual impression and lead to cracking and to unwanted light scattering effects. In the production of a polyolefin fiber, pigment agglomerates result in clogging of the extruder's melt screen and in fiber breakage, which generally entails prolonged downtime and -increased cleaning work on equipment.

Pigment concentrates and processes for preparing them, for the abovementioned applications, can be found in the prior art. For instance, DE-B 12 39 093 describes a carrier material based on a mixture of an amorphous ethylene-propylene block copolymer and a crystalline polypropylene for the preparation of pigment concentrates. DE-A 26 52 628 relates to the use of polypropylene waxes having a viscosity of from 500 to 5000 mPas (170° C.) and an isotactic fraction of from 40 to 90%.

In DE 195 16 387 A1, a high effective dispersion is achieved by virtue of a dispersant which is a mixture of different polyolefin components and specific polyacrylates.

The prior art pigment preparations can be prepared in the solid state by mixing as a dry blend, and/or by melt mixing in appropriate extruders or kneading apparatus.

Normally, the powderous organic or inorganic pigments are mixed together with granular or powderous polyolefins and corresponding polyolefin waxes. The polyolefin waxes are also used in powder form. The prior art pigments are obtained either by spray techniques or grinding processes.

The particle sizes of these waxes are generally <1000 μm. Depending on the process used, the particle size distributions will of course vary.

Depending on pigment type, optimum dispersion requires up to 40% by weight of wax. Since excessive quantities of wax always result in instances of migration and deposits on the dies, there is particular advantage in preparing pigment concentrates comprising well-dispersed pigments with minimum fractions of polyolefin waxes.

### SUMMARY OF THE INVENTION

An object of the present invention is to prepare pigment concentrates having as small as possible a fraction of polyolefin waxes and at the same time a high dispersing quality. It must be ensured that these pigment concentrates can be used without restriction in known applications, i.e., that in terms of their profile of properties they can also be used without restriction for the coloring of textile fibers.

### DETAILED DESCRIPTION OF THE INVENTION

The above object is achieved by preparing pigment concentrates using micronized powders based on polyolefins and/or polyolefin waxes having a higher specific surface area, as obtained, for example, by cryogenic grinding using an air jet mill.

The present invention therefore provides in a first embodiment, pigment concentrates comprising micronized polyolefins and/or polyolefin waxes prepared by grinding polyolefins and/or polyolefin waxes, wherein the proportion of the particle size fraction smaller than 10 μm is at least 1% by weight, the proportion of the particle size fraction less than 100 μm is at least 10% by weight, and the proportion of the particle size fraction less than 500 μm is at least 90% by weight.

The particle size distributions of these powders should preferably lie between 10 and 100 μm in order to obtain a good dispersing action.

The use of these micronized polyolefins and/or polyolefin waxes in accordance with the present invention makes it possible to prepare highly concentrated pigment concentrates having a markedly reduced wax fraction or pigment concentrates that are entirely devoid of wax components.

The pigment concentrates of the present invention comprise from 10 to 60% by weight of a conventional pigment; and from 40 to 90% by weight of a micronized polyolefin powder of the present invention. In other embodiments, the pigment concentrates of the present invention comprise 10 to 60% by weight of a conventional pigment; 10 to 50% by weight of a micronized polyolefin powder of the present invention (polyolefin and/or polyolefin wax); and 10 to 80% by weight of an additional polyolefin such as polyethylene or polypropylene. The additional polyolefin is referred to herein as a polymeric carrier.

To prepare the micronized polyolefins (POs) or polyolefin waxes (POWs) of the present invention, it is possible, in principle, to use known prior art grinding processes such as disk milling and impact milling. Moreover, any conventional POs and POWs known to those skilled in the art can be employed in the present invention. Depending on the chosen grinding conditions, the fineness of the products obtained can be carefully varied within a wide range. A modular impact mill (Hosokawa Mikropul) has been found particularly suitable for preparing micronized products of the present invention.

Important distinguishing criteria of the polyolefins and/or polyolefin waxes used in the present invention, relative to the prior art, are the particle size distributions and upper sieve cutoffs of the products.

The following examples are given to illustrate the present invention as well as to illustrate some advantages that can be obtained therefrom.

### WORKING EXAMPLES

1) Preparation of the Micronized Polyolefins and Polyolefin Waxes:

Table 1 lists the corresponding grinding conditions for the products used and, for characterization, the resultant particle size distributions with the corresponding upper sieve cutoffs. Examples with the letter A relate to nonmicronized products of the prior art for the preparation of pigment concentrates and thus are not in accordance with the present invention. The letters B, C and D after the example number describe the use of the micronized products in accordance with the present invention.

TABLE 1
Particle size distributions and upper sieve cutoffs of the polyolefins
and/or polyolefin waxes used

| | POLYOLEFIN | GRINDING | | | | | |
|---|---|---|---|---|---|---|---|
| EX- | (PO) OR | CONDITIONS | PARTICLE | | | UPPER | |
| AM- | POLYOLEFIN | MILL/TEM- | SIZE | | | SIEVE | |
| PLE | WAX (POW) | PERATURE | DISTRIBUTION | | | CUTOFFS | |
| 1A | Polypropylene | Disk mill/ | 0% | <10 | μm | 2000 | μm |
| | wax¹ (POW) | room | 0.1% | <100 | μm | | |
| | | temperature | 33% | <500 | μm | | |
| 1B | Polypropylene | Disk mill/ | 1.1% | <10 | μm | 500 | μm |
| | wax¹ (POW) | −30° C. | 35% | <100 | μm | | |
| | | | 98% | <500 | μm | | |
| 2A | Tego ® wax | Disk mill/ | 0.1% | <10 | μm | 1400 | μm |
| | P121² (POW) | room | 3.0% | <100 | μm | | |
| | | temperature | 45% | <500 | μm | | |
| 2B | Tego ® wax | Disk mill/ | 1.3% | <10 | μm | 500 | μm |
| | P121² (POW) | −30° C. | 42% | <100 | μm | | |
| | | | 99% | <500 | μm | | |
| 2C | Tego ® wax | Impact mill/ | 13% | <10 | μm | 500 | μm |
| | P121² (POW) | −50° C. | 88% | <100 | μm | | |
| | | | 99% | <500 | μm | | |
| 3A | Polypropylene² | Disk mill/ | 0% | <10 | μm | 1000 | μm |
| | (PO) | −10° C. | 1.2% | <100 | μm | | |
| | | | 68% | <500 | μm | | |
| 3B | Polypropylene³ | Impact mill/ | 4.9% | <10 | μm | 500 | μm |
| | (PO) | −100° C. | 47% | <100 | μm | | |
| | | | 97% | <500 | μm | | |
| 4A | Polyethylene | Sprayed | 0% | <10 | μm | 2000 | μm |
| | wax⁴ (POW) | | 0% | <100 | μm | | |
| | | | 7% | <500 | μm | | |
| 4B | Polyethylene | Impact mill/ | 11% | <10 | μm | 500 | μm |
| | wax⁴ (POW) | −100° C. | 96% | <100 | μm | | |
| | | | 99% | <500 | μm | | |
| 5A | Polyethylene⁵ | Disk mill/ | 0% | <10 | μm | 1000 | μm |
| | (PO) | room | 2.6% | <100 | μm | | |
| | | temperature | 99% | <500 | μm | | |
| 5B | Polyethylene⁵ | Impact mill/ | 2.2% | <10 | μm | 1000 | μm |
| | (PO) | −100° C. | 98.6% | <100 | μm | | |
| | | | 99% | <500 | μm | | |

¹A polypropylene wax was used having a softening point of 160° C. in a density of 0.88 g/cm³
²Dispersing wax compound from Th. Goldschmidt AG; dropping point about 115° C., density 0.93 g/cm³
³A polypropylene was used having an MFI of 45 (230° C./2.16 kg) and a density of 0.91 g/cm³.
⁴A polyethylene wax was used having a dropping point of 110 to 115° C. and a density of 0.91 g/cm³.
⁵A polyethylene was used having an MFI of 200 (190° C./2.16 kg) and a density of 0.92 g/cm³.

Table 1 shows the marked influence of the grinding conditions on the particle size distributions. Micronized products are notable in the distribution by a high proportion of particle size fractions smaller than 100 μm (1 μm=10⁻⁶ m).

The pigment preparations were prepared by premixing the corresponding individual components. (pigment/wax/polymeric carrier) in the specified proportions (Table 2) followed by melt mixing in a twin-screw extruder from Leistritz (Modell: Micro 27 GL 40D). The pigment component used was either a red pigment (Pigment Red 57:1/Irgalith® Ruby 4 BP, Ciba) or a phthalocyanine blue (Pigment Blue 15:3/Heliogenblau K 7090, BASF). The polymeric carrier used was either polypropylene (MFI=45; 230° C./2.16 kg) or a polyethylene (LDPE, MFI=20; 190° C./2.16 kg).

The corresponding proportions by weight are given in brackets in Table 2.

TABLE 2
Production of the pigment preparations

| | Polyolefin or polyolefin | | | | |
|---|---|---|---|---|---|
| | wax from Example No. | | Pigment type | | Polymer carrier |
| Example | (proportions) | | (30 parts) | | (proportions) |
| 6A | 1A | (30) | Red | 57:1 | Polypropylene (40) |
| | | | Blue | 15:3 | |
| 6B | 1B | (30) | Red | 57:1 | Polypropylene (40) |
| 7A | 2A | (20) | Red | 57:1 | Polypropylene (40) |
| 7B | 2B | (20) | Red | 57:1 | Polypropylene (40) |
| 7C | 2C | (20) | Red | 57:1 | Polypropylene (40) |
| 7D | 2C | (20) | Blue | 15:3 | Polypropylene (40) |
| 8A | 3A | (70) | Red | 57:1 | — |
| 8B | 3B | (70) | Red | 57:1 | — |
| 8C | 3B | (70) | Blue | 15:3 | — |
| 9A | 4A | (20) | Red | 57:1 | Polypropylene (40) |
| 9B | 4B | (20) | Red | 57:1 | Polypropylene (40) |
| 10A | 5A | (70) | Red | 57:1 | — |
| 10B | 5B | (70) | Red | 57:1 | — |

In order to assess the dispersing quality of pigments in color masterbatches, it is common to use a pressure filter test. In this test, a mixture of masterbatch and polymeric carrier with a pigment content of 10% by weight is melted in an extruder and extruded through a defined filter sequence. The rise in pressure is monitored over a defined period (1 h). The pressure filter value (PFV) is measured to determine the quality of the masterbatch, and is given by the following formula:

PFV=(Pₘₐₓ−Pₒ)×F×100/t×K×G(bar×cm²/g)

where

Pₘₐₓ=final pressure (bar)

Pₒ=pressure when operating without masterbatch

F=filter area (cm²)

t=measurement period (min)

K=concentration (%)

G=extruder throughput (g/min)

The pressure filter value indicates the extent to which a filter sequence becomes blocked by agglomerates. A very low pressure filter value indicates very good dispersing of the pigments.

Another test to determine the dispersing quality is the determination of the Chroma of a masterbatch. In this case, the masterbatch is diluted with the polymeric carrier to a pigment content of 0.2% by weight and is whitened with titanium dioxide (10 parts by weight of titanium dioxide per part by weight of pigment). This material is injection molded to form sheets, on which Chroma measurements are made. The CIE-L_{ab} color system has proven appropriate for these measurements.

The higher the Chroma in comparison with a reference sample, the better the distribution of the pigment, and the lower the agglomerate fraction in the parent color masterbatch.

For the purpose of the comparison, the Chroma of the reference samples is set by definition at 100%.

Table 3 indicates the corresponding results for pigment concentrates, as obtained in accordance with the prior art or in accordance with the present invention, i.e., based on the ground products.

TABLE 3
Pressure filter values and results of the Chroma
measurements

| | Pressure filter values | | | |
|---|---|---|---|---|
| | (bar × cm²/g) | | Chroma (%) | |
| Example No. | Red 57:1 | Blue 15:3 | Red 57:1 | Blue 15:3 |
| 6A | 18.5 | 6.5 | 100 | 100 |
| 6B | 9.5 | | 112 | |
| 7A | 6.6 | | 120 | |
| 7B | 2.5 | | 124 | |
| 7C | 0.5 | | 130 | |
| 7D | 1.8 | | — | 130 |
| 8A | 28.0 | | 92 | |
| 8B | 1.2 | | 125 | |
| 8C | 2.5 | | | 124 |
| 9A | 8.5 | | 100 | |
| 9B | 1.6 | | 126 | |
| 10A | 10.5 | | 77 | |
| 10B | 4.5 | | 118 | |

Noteworthy are the considerably improved results in respect of pressure filter value and Chroma when the micronized products of the present invention are used. Furthermore, the grinding of high molecular mass polyolefins makes it possible to reduce the amount of polyolefin waxes or omit them completely. It is therefore even possible to formulate wax-free pigment concentrates.

The results obtained represent. only a selection of the possibilities which exist, and should not be regarded as a restriction.

While the present invention has been particularly shown and described with respect to preferred embodiments thereof, it will be understood by those skilled in the art that the foregoing and other changes in form and detail may be made without departing from the spirit and scope of the present invention. It is therefore intended that the present invention not be limited to the exact forms and details described and illustrated, but fall within the appended claims.

What is claimed is:

1. A composition comprising micronized polyolefins, polyolefin waxes or combinations thereof, wherein
a proportion of the particle size fraction smaller than 10 μm of said composition is at least 1% by weight, a proportion of the particle size fraction smaller than 100 μm of said composition is at least 10% by weight, and a proportion of the particle size fraction smaller than 500 μm of said composition is at least 90% by-weight.

2. The composition of claim 1 wherein said composition comprises a micronized polyolefin.

3. The composition of claim 1 wherein said micronized polyolefin is micronized polyethylene or micronized polypropylene.

4. The composition of claim 1 wherein said composition comprises a micronized polyolefin wax.

5. The composition of claim 1 further comprising a pigment and optionally a polymeric carrier.

6. The composition of claim 5 wherein said pigment is a red pigment or phthalocyanine blue.

7. The composition of claim 5 wherein said polymeric carrier is composed of polyethylene or polypropylene.

8. A pigment concentrate comprising:
from 10to 60% by weight of a pigment; and
from 40 to 90% by weight of a micronized polyolefin, a micronized polyolefin wax or a combination thereof, said micronized material having a proportion of the particle size fraction smaller than 10 μm of at least 1% by weight, a proportion of the particle size fraction smaller than 100 μm is at least 10% by weight, and a proportion of the particle size fraction smaller than 500 μm is at least 90% by weight.

9. The pigment concentrate of claim 8, comprising from 10 to 60% by weight of said pigment;
from 10 to 50% by weight of said micronized polyolefin or micronized polyolefin wax; and
10 to 80% by weight of a polymeric carrier.

10. The pigment concentrate of claim 8 wherein said micronized polyolefin is micronized polyethylene or micronized polypropylene.

11. The pigment concentrate of claim 8 wherein said pigment is a red pigment or phthalocyanine blue.

12. The pigment concentrate of claim 9 wherein said polymeric carrier is composed of polyethylene or polypropylene.

13. A colored finished polyolefin product comprising at least the pigment concentrate of claim 8.

14. The colored finished polyolefin product of claim 13 wherein said pigment concentrate comprises from 10 to 60% by weight of said pigment; from 10 to 50% by weight of said micronized material; and from 10 to 80% by weight of a polymeric carrier.
